(19) United States
(12) Patent Application Publication
(10) Pub. No.: US 2026/0332629 A1
(43) Pub. Date: Oct. 22, 2026

(54) MULTI-HOP SHADOW DATA PLANE TRAFFIC HANDLING

(71) Applicant: Cisco Technology, Inc., San Jose, CA (US)

(72) Inventors: David John Zacks, Vancouver (CA); Yeneneh Gobena, Cary, NC (US); Hazim Hashim Dahir, Wake Forest, NC (US); Vivek Santuka, Morrisville, NC (US); John Michael Lake, Cary, NC (US)

(21) Appl. No.: 19/180,621

(22) Filed: Apr. 16, 2025

(51) Int. Cl. H04L 9/40

(52) U.S. Cl. CPC H04L 63/1433; H04L 63/0236; H04L 63/1425

(57) ABSTRACT

Systems and methods for managing flow of data within a controlled boundary using a shadow data plane are disclosed. The method includes forwarding unmarked dataflow to a next port or resource, processing marked dataflow by an active data plane and a shadow data plane, dropping marked dataflow by the active data plane, processing marked dataflow by the shadow data plane, forwarding marked dataflow to the next port or resource, and processing unmarked dataflow by the shadow data plane. The method enables comprehensive testing and validation of policies and configurations across the entire data path.

### TECHNICAL FIELD

The present technology pertains to network traffic routing in a network, and more specifically to providing testing and verification of policies and configurations that impact traffic handling across multiple nodes.

### BACKGROUND

Networks are increasingly becoming complex systems that require sophisticated management and optimization to ensure reliable and efficient communication. With the proliferation of devices, data centers, and cloud services, network traffic is growing exponentially, making it challenging for traditional infrastructure to keep pace. To achieve optimal performance, network administrators must carefully design and optimize their networks, taking into account factors such as traffic patterns, device interactions, and policy enforcement. However, existing solutions often fall short in addressing such complex challenges involving testing and verifying policies across multiple hops.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1A is a schematic block diagram of a non-limiting example of a computer network, according to some aspects of the present disclosure.

FIG. 1B illustrates an example of the network in FIG. 1A in greater detail, according to some aspects of the present disclosure.

FIG. 2 is a schematic block diagram of an example node/device, according to some aspects of the present disclosure.

FIG. 3 illustrates a non-limiting example of a dual data plane architecture for a network appliance or network device, according to some aspects of the present disclosure.

FIG. 4 illustrates a non-limiting example of a DPU dual data plane architecture, according to some aspects of the present disclosure.

FIG. 5 illustrates a diagram of an example cloud data center architecture, according to some aspects of the present disclosure.

FIG. 6 illustrates an example method for managing flow of data within a controlled boundary using a shadow data plane, according to some aspects of the present disclosure

FIG. 7 illustrates a first example method for marking dataflow, according to some aspects of the present disclosure.

FIG. 8 illustrates a second example method for marking dataflow, according to some aspects of the present disclosure.

FIG. 9 illustrates a third example method for marking dataflow, according to some aspects of the present disclosure.

FIG. 10 illustrates a fourth example method for marking dataflow, according to some aspects of the present disclosure.

FIG. 11 illustrates a fifth example method for marking dataflow, according to some aspects of the present disclosure.

FIG. 12 illustrates an example of a computing system, according to some aspects of the present disclosure.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The present technology addresses the current limitations by introducing the concept of a "shadow data plane" that operates in parallel with the active data plane within a network device. The shadow data plane processes all or a selected subset of the traffic, allowing it to be tested and validated without affecting the live production traffic flowing through the active data plane.

The key to such an approach is the ability to selectively mark certain traffic flows for processing by the shadow data plane. The marking can be done in a variety of ways, including using unused or reserved bits in the IP, TCP, or Ethernet headers, or by leveraging metadata propagation techniques. The in-band explicit markings or out-of-band implicit markings allow the network device to identify which traffic should be directed to the shadow data plane.

The technology may extend beyond a single network device, enabling the shadow data plane concept to be applied across multiple hops in the network. As marked traffic traverses the network, each device along the path can recognize the marking and process that traffic through its own shadow data plane. The technology provides comprehensive testing and validation of policies and configurations across the entire data path.

By decoupling the active production traffic from the test/validation traffic in such a manner, network operators can confidently deploy configuration changes, software upgrades, and new policies without fear of disrupting live services. The shadow data plane approach allows for rigorous testing and validation before committing changes to the active production environment. The technology further improves network reliability, agility, and the ability to rapidly innovate.

In addition, the technology may extend beyond networking devices and may be utilized in other environments, such as containers or clusters in a data center compute architecture.

As such, the shadow data plane allows testing and validation of configuration changes, policy updates, and software upgrades without impacting the active production traffic flowing through the network. By thoroughly testing changes in the shadow data plane before activating them, network operators can reduce the risk of unintended consequences that could disrupt live services. Additionally, the ability to quickly test new features, policies, and optimizations in the shadow data plane empowers network teams to innovate and adapt more quickly to changing business requirements. Furthermore, the shadow data plane provides greater visibility into how traffic would be processed by new configurations, allowing for deeper analysis and troubleshooting before deployment. If issues are detected in the shadow data plane, the network can easily revert to the previous stable configuration without impacting production traffic, and the ability to selectively mark traffic and have it processed by shadow data planes at multiple network devices enables comprehensive end-to-end testing of policies and configurations.

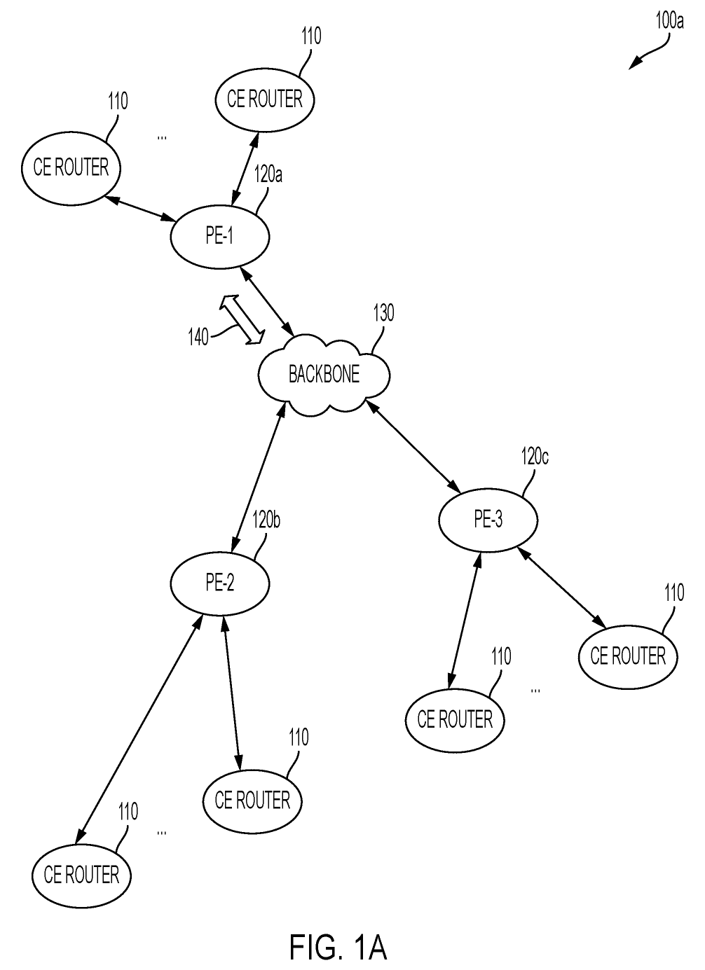

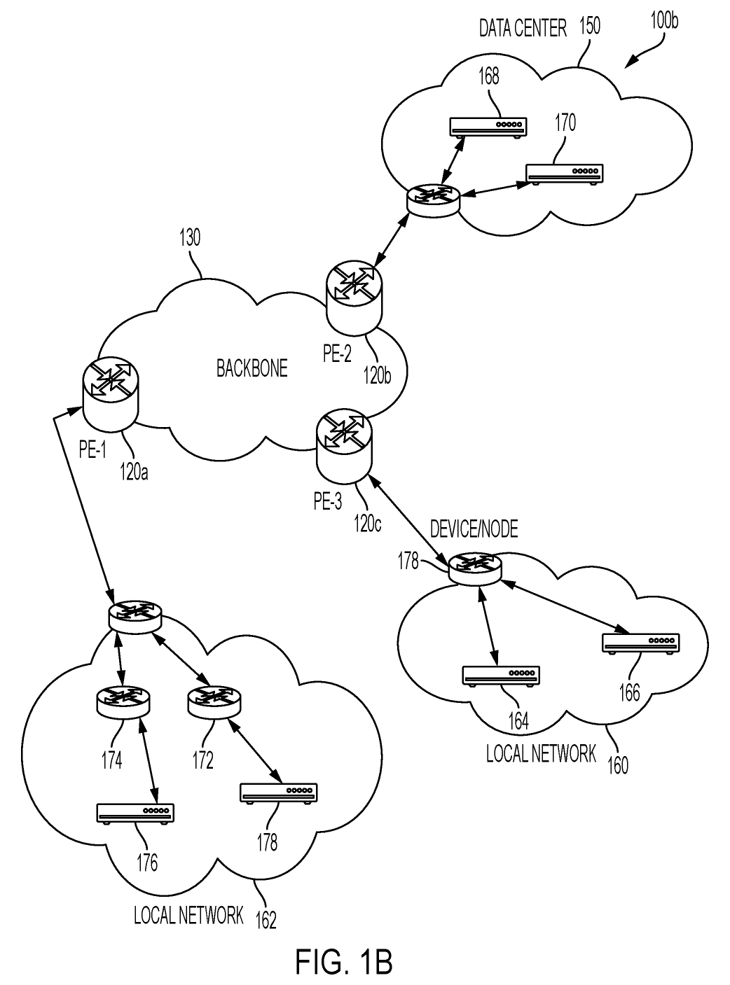

FIG. 1A is a schematic block diagram of a non-limiting example of a network 100a that includes various nodes/devices, such as a plurality of routers/devices interconnected by links or networks.

For example, customer edge routers 110 may be interconnected with provider edge routers (e.g., provider edge router 120a (PE-1), provider edge router 120b (PE-2), and provider edge router 120c (PE-3)) to communicate across a core network, such as a network backbone 130. For example, the routers (e.g., customer edge routers 110, provider edge router 120a, provider edge router 120b, provider edge router 120c) may be interconnected by the public Internet, a multiprotocol label switching (MPLS), or a virtual private network (VPN). Data packets 140 (e.g., traffic/messages) may be exchanged among the nodes/devices of the computer network over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN utilizing a Service Provider network, via one or more links exhibiting very different network and service level agreement characteristics.

According to certain non-limiting examples, a given customer site may fall under one or more of the following categories:

Site Type A: a site connected to the network (e.g., via a private or VPN link) using a single customer edge router and a single link, with potentially a backup link (e.g., a 3G/4G/5G/LTE backup connection). For example, a customer edge routers 110 shown in the network 100a may support a given customer site, potentially also with a backup link, such as a wireless connection.

Site Type B: a site connected to the network using two MPLS VPN links (e.g., from different Service Providers) using a single customer edge router, with potentially a backup link (e.g., a 3G/4G/5G/LTE connection). A site of type B may itself be of different types:

Site Type B1: a site connected to the network using two MPLS VPN links (e.g., from different Service Providers), with potentially a backup link (e.g., a 3G/4G/5G/LTE connection).

Site Type B2: a site connected to the network using one MPLS VPN link and one link connected to the public Internet, with potentially a backup link (e.g., a 3G/4G/5G/LTE connection). For example, a particular customer site may be connected to network 100a via provider edge-3 and via a separate Internet connection, potentially also with a wireless backup link.

Site Type B3: a site connected to the network using two links connected to the public Internet, with potentially a backup link (e.g., a 3G/4G/5G/LTE connection).

Site Type C: a site of type B (e.g., types B1, B2 or B3) but with more than one customer edge router (e.g., a first customer edge router connected to one link while a second customer edge router is connected to the other link), and potentially a backup link (e.g., a wireless 3G/4G/5G/LTE backup link). For example, a particular customer site may include a customer edge router 110 (e.g., a first customer edge router) connected to provider edge router 120b (PE-2) and a customer edge router 110 (e.g., a second customer edge router) connected to provider edge router 120c (PE-3).

FIG. 1B illustrates an example of network 100b in greater detail, according to various embodiments. As shown, network backbone 130 may provide connectivity between devices located in different geographical areas and/or different types of local networks. For example, network 100b may comprise local/branch networks 160 and local/branch networks 162 that include device/node 172, device/node 174, device/node 176, and device/node 178 and device/node 164 and device/node 166, respectively, as well as a data center 150 that includes server 168 and server 170. Notably, local/branch network 160, local/branch network 162, and data center 150 can be located in different geographic locations.

Server 168 and server 170 can include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100b may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

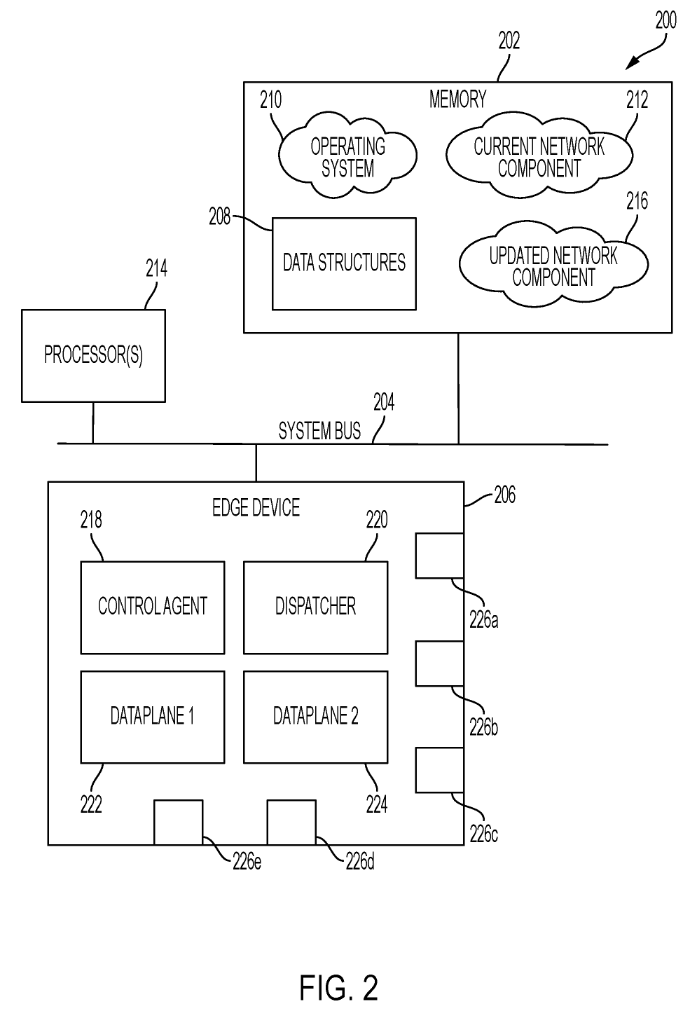

FIG. 2 is a schematic block diagram of an example node/device 200 (e.g., an apparatus) that may be used with one or more embodiments described herein, e.g., as any of the computing devices shown in FIGS. 1A and 1B. The device 200 may also be any other suitable type of device depending upon the type of network architecture in place, such as IoT nodes, etc. Device 200 can include one or more edge devices, one or more processor(s) 214, and a memory 202 interconnected by a system bus 204.

The edge device 206 can include the mechanical, electrical, and signaling circuitry for communicating data over physical links coupled to the network 100a/100b. The edge device 206 can be configured to transmit and/or receive data using a variety of different communication protocols. the edge device 206 can also be used to implement one or more virtual network interfaces, such as for virtual private network (VPN) access, known to those skilled in the art. The edge device 206 can be implemented as software executed on a central processing unit (CPU), such as a virtual machine like a Berkley packet filter (BPF) or extended BPF (eBPF) that is configured to implement a network policy, for example. Alternatively or additionally, The edge device 206 can be implemented as a separate piece of hardware (e.g., a data processing unit (DPU), a graphics processing unit (GPU), a smart network interface card (smartNIC), a network interface controller, an application-specific integrated circuit (ASIC), field programable gate array (FPGA), or other device/circuitry configured to perform the function of a network component).

The edge device 206 can be configured to provide one or more network functions, including, e.g., data-packet filtering, load balancing, packet screening, pattern detection for cybersecurity threats, malware detection, firewall protection, data-packet routing, data-packet switching, data-packet forwarding, computing header checksums, or implementing network policies. According to certain non-limiting examples, the edge device 206 can be an embedded device at the network edge. The edge device 206 can include (or be part of) a software-defined wide area network (SD-WAN) appliance, a firewall, or a load balancer, for example. Moreover, the systems and methods disclosed herein can be used with any edge device 206 that includes a data plane that can be intermittently updated to a new version.

The edge device 206 can include a data plane, a control plane, and a management plane, as discussed above. Further, instructions implementing the control plane and the management plane can be stored and/or executed in the processor(s) 214. Additionally or alternatively, the edge device 206 can include processors or circuits that implement one or more functions of the control plane and the management plane. The edge device 206 can include a series of ports (e.g., port 226a (1), port 226b (2), port 226c (3), port 226d (3), and port 226e (5)). The edge device 206 can also include a control agent 218, a dispatcher 220, a data plane 222 (data plane 1), and a data plane 224 (data plane 2).

Memory 202 can include a plurality of storage locations that are addressable by the processor(s) 214 and the edge device 206 for storing software programs and data structures associated with the embodiments described herein. Memory 202 can include data structures 208 and can include instructions for executing the operating system 210, the current network component 212, and the updated network component 216. The processor(s) 214 can include logic adapted to execute the software programs and manipulate the data structures 208. An operating system 210 (e.g., the Internetworking Operating System, or IOS®, of Cisco Systems, Inc., another operating system, etc.), portions of which can be in memory 202 and executed by the processor(s), functionally organizes the node by, inter alia, invoking network operations in support of software processors and/or services executing on the device.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

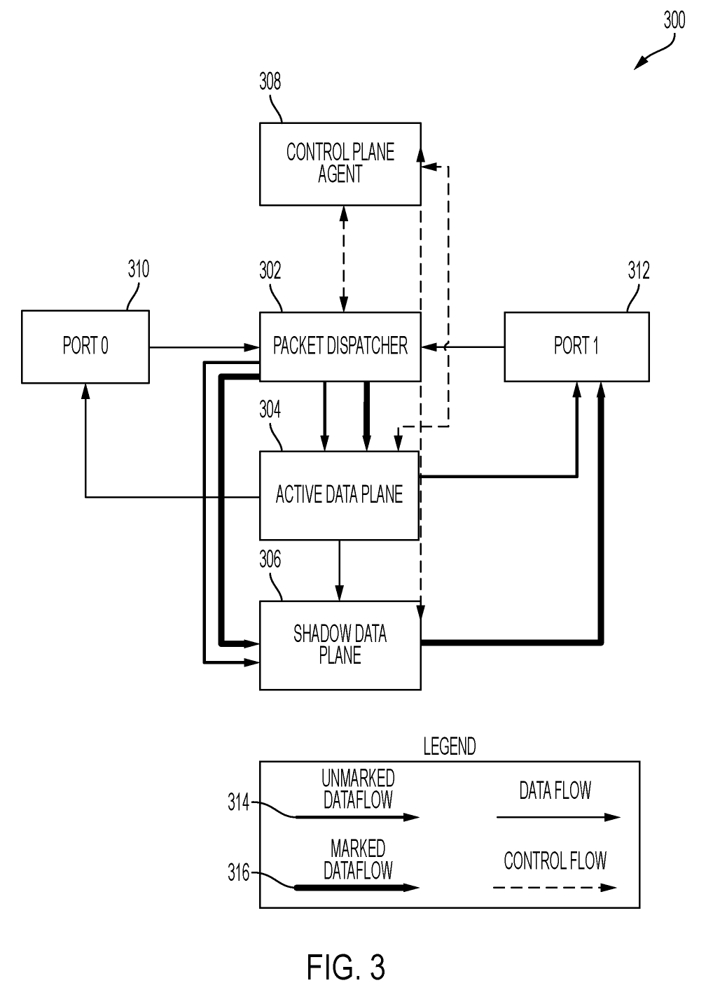

FIG. 3 illustrates a non-limiting example of a dual data plane architecture for a network appliance or network device.

The dual data plane architecture 300 is a network security framework that enables the distribution of security policies across multiple nodes within a network. The framework incorporates an alternative processing pathway for testing and validating security policies in real-time without disrupting live traffic. Unlike traditional methods that rely on centralized security measures such as firewalls, the dual data plane architecture 300 may further distribute security functions, allowing for greater flexibility and scalability.

The distribution may be achieved through the ability to craft and enforce security policies at various levels—node level, host level, or network level—ensuring comprehensive protection across the entire infrastructure. A key component of dual data plane architecture 300 is its reliance on technologies like eBPF (Extended Berkeley Packet Filter), which provides deep visibility into system operations by intercepting kernel-level calls. By operating at different levels within the network, the dual data plane architecture 300 enhances security measures through proactive management while maintaining operational continuity.

One of the standout features of the dual data plane architecture 300 is its ability to test and validate security policies in a live environment without disrupting operations. The testing and validating may be accomplished through the use of a shadow data plane architecture. In traditional systems, traffic is processed through a single active data plane, but the dual data plane architecture 300 introduces a parallel shadow data plane that operates alongside it. Incoming traffic is replicated at the node level, with one stream processed by the active data plane and the other by the shadow data plane. The shadow data plane functions independently of the active data plane, allowing for real-time testing of new or modified security policies. While the active data plane continues to handle live traffic as usual, the shadow data plane processes replicated traffic in parallel. The setup enables the gathering of statistics and insights about how the traffic would behave under different policy configurations without affecting the live environment. Once the policies in the shadow data plane have been validated and optimized, they can be seamlessly transitioned into the active data plane through a simple bit flip or configuration change.

The dual data plane architecture 300 is designed to handle a canonical pipeline involving multiple functions along the path of data flow, including firewall capabilities, MADDIC (a multi-adaptive detection and defense-in-depth framework), and IPsec encryption. Such functions may be realized on multiple nodes or distributed processing units (DPUs) within the network. For instance, the firewall capability is separated into ingress and egress checks with a routing step in between, which may involve two different DPUs. Similarly, MADDIC is implemented as a unitary function but operates alongside a shadow capability for testing and validation. To facilitate the distributed approach, the framework includes mechanisms for state exchange between primary and shadow instances of such functions. For example, the firewall, MADDIC, and other components may maintain both primary and shadow capabilities, which make coordinated decisions based on their allocation policies. State updates made by the primary instance are immediately visible to the shadow instance through shared memory or similar mechanisms, ensuring synchronization.

The term "shadow" refers to a hidden or shadowing data structure that allows the shadow instance to record different decisions than those it would have made under normal policy enforcement. The capability is critical for testing and validation purposes, as it enables the system to evaluate how changes to policies would affect traffic without impacting live operations. For example, if network address translation (NAT) or similar transformations are applied, the same process must be mirrored in both the primary and shadow instances to maintain consistency. The framework also supports both on-box and distributed box sharing of state information. On-box sharing refers to the exchange of state data between components within a single node or device, while distributed box sharing involves coordination across multiple nodes or devices in the network. In some cases, a rebroadcast step may be required to ensure that state updates are propagated efficiently across the distributed system.

Such an innovative approach ensures that security updates and changes can be tested thoroughly before being implemented, minimizing risks and potential disruptions to network operations. Furthermore, the ability to replicate and process traffic across multiple nodes in the shadow data plane allows for a comprehensive evaluation of how policies would perform at various points along the traffic path. The distributed testing capability is a significant advancement over traditional methods, which often rely on isolated lab environments that may not fully reflect real-world conditions. In summary, the use of a shadow data plane provides a robust framework for testing and validating security policies in a live environment, ensuring that updates are both effective and reliable.

As illustrated in FIG. 3, ingress packets are received through port 310 (port 0) and port 312 (port 1) to the packet dispatcher 302, and then the packet dispatcher 302 forwards data packets to the active data plane 304 and the shadow data plane 306. Unmarked dataflow 314 is handled in a default manner. Unmarked dataflow 314 forwarded to the active data plane 304 may be forwarded to port 312 (port 1), maintaining its normal treatment.

However, when marked dataflow 316 reaches the active data plane 304, it undergoes a different process. Marked dataflow 316 may be processed then dropped. For the shadow data plane 306, unmarked dataflow 314 is also handled in the default manner. Unmarked dataflow 314 is processed by the shadow data plane 306 then dropped. However, when marked dataflow 316 reaches the shadow data plane 306, it also undergoes a different process. The shadow data plane 306 processes and forwards the marked dataflow 316 to port 312 (port 1).

As such, the dual data plane architecture 300 enables multi-hop shadow data plane traffic handling, verification, and enforcement through the use of marking on marked dataflow 316. The ability of the markings to survive multiple hops across the domain involved makes it possible to test multi-hop policies where the traffic is modified by nodes along the designated path. Such a capability allows for testing of complex scenarios that would be difficult or impossible to replicate using traditional single-node testing methods. Moreover, marking traffic on a packet-by-packet basis provides an extremely granular method of testing new policies and software images across multiple devices in the shadow data plane 306. The targeted approach enables testers to validate the effectiveness of updated policies against a wide range of scenarios, ensuring that changes are thoroughly tested before deployment. The end result is more comprehensive and reliable multi-hop traffic flow testing and verification within the domain.

In FIG. 3 the packets from the active data plane 304 are transmitted to port 310 (port 0) and port 312 (port 1). Control signal flow between the control plane agent 308 and each of the packet dispatcher 302, the active data plane 304, and the shadow data plane 306. Further, control signal can flow from the active data plane 304 to the shadow data plane 306.

The dual data plane architecture 300 may include a shared memory that can be accessed by respective components of the dual data plane architecture 300, including, e.g., being accessed by the packet dispatcher 302, active data plane 304, shadow data plane 306, and control plane agent 308. The shared memory enables the data planes to operate as stateless as possible by storing state-type information in the shared memory, which is accessible by all components of the system. As such, the packet dispatcher 302 is allowed to monitor the performance of both data planes. Further, such features can also allow flows to be migrated from one data plane to the other since the state is isolated.

The shared memory can enable coordination of which of the packets egressing from the active data plane and the shadow data plane are selected as the output packets from the dual data plane architecture 300. Using the shared memory enables coordination between the primary and shadow data planes to ensure that each packet processed along both data planes is included once and only once in the output packets, and the shared memory enables a graceful and gradual transition between the output packets originally egressing from the active data plane to finally egressing from the shadow data plane at the end of the transition period.

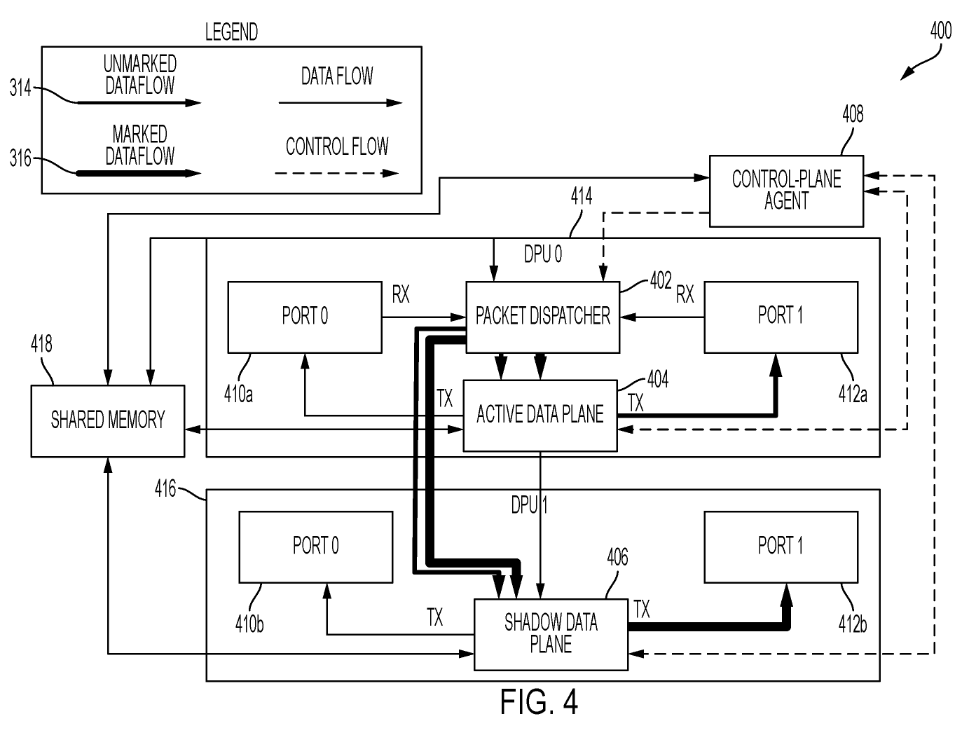

FIG. 4 illustrates a non-limiting example of a DPU dual data plane architecture.

Descriptions of the functions of the DPU dual data plane architecture have been provided above in reference to FIG. 3, and therefore such descriptions are not repeated here. Some differences between the dual data plane architecture 300 and the DPU dual data plane architecture 400 are noted here.

The DPU dual data plane architecture 400 includes a shared memory 418 that can be accessed by respective components of the DPU dual data plane architecture 400, including, e.g., being accessed by the packet dispatcher 402, active data plane 404, shadow data plane 406, and control-plane agent 408. The shared memory 418 enables the data planes to operate as stateless as possible by storing state-type information in the shared memory 418, which is accessible by all components of the system. As such, the packet dispatcher 402 is allowed to monitor the performance of both data planes. Further, such features can also allow flows to be migrated from one data plane to the other since the state is isolated.

In DPU environments, however, it may not be possible for the data planes to run entirely stateless, e.g., when leveraging hardware acceleration. As illustrated in FIG. 4, ingress packets are received through port 410a (port 0) and port 412a (port 1) of DPU 414 (DPU 0), and then the ingress packets are transmitted from the respective ports to the packet dispatcher 402. The packet dispatcher 402 then selects which of such data packets to direct to the active data plane 404 and which to the shadow data plane 406. The marked dataflow 316 and unmarked dataflow 314 are directed to both the active data plane 404 and the shadow data plane 406. Similar to FIG. 3, unmarked dataflow 314 is handled in a default manner. Unmarked dataflow 314 forwarded to the active data plane 404 may be forwarded to port 412a (port 1), maintaining its normal treatment.

However, when marked dataflow 316 reaches the active data plane 304, it undergoes a different process. Marked dataflow 316 may be processed then dropped. For the shadow data plane 406, unmarked dataflow 314 is also handled in the default manner. Unmarked dataflow 314 is processed by the shadow data plane 406 then dropped. However, when marked dataflow 316 reaches the shadow data plane 406, it also undergoes a different process. The shadow data plane 406 processes and forwards the marked dataflow 316 to port 412b (port 1).

In FIG. 4, packets from the active data plane 404 are transmitted to port 410a (port 0) and port 412a (port 1) of DPU 414 (DPU 0), and the packets from the shadow data plane 406 are transmitted to port 410b (port 0) and port 412b (port 1) of DPU 416 (DPU 1). Control signals can flow between the control-plane agent 408 and each of the packet dispatcher 402, the active data plane 404, and the shadow data plane 406.

Building upon the DPU dual data plane architecture 400 illustrated in FIG. 4 additional complexity arises when multiple functions are distributed across multiple nodes. As shown in FIG. 4, each DPU node (0 and 1) has a packet dispatcher, active data plane, shadow data plane, and control-plane agent. The setup enables stateless operations between the data planes by storing state-type information in shared memory. However, when multiple functions are distributed across multiple nodes, additional complexity arises.

For instance, consider the security pipeline that involves a firewall followed by MADDIC (Multi-Attribute Decision-Distribution) and then IPsec encryption on the way out. The pipeline is typically realized on a single node but may be decomposed into separate components and distributed across multiple nodes. In such a scenario, shadowing each data plane involved in the security pipeline is desired. The canonical pipeline involves a firewall followed by MADDIC, followed by IPsec encryption. Each component of the pipeline might be realized on multiple nodes, with the possibility that two or more nodes perform distinct versions of the same function. For example, the firewall capability today is separated into ingress and egress checks, with each check running on a separate DPU node (0 or 1). Similarly, MADDIC may be decomposed into unitary components, one for the active data plane and another for the shadow data plane, resulting in two instances of MADDIC capability, one for the primary node and one for the shadow node.

In such a scenario, the primary and shadow nodes must make coordinated decisions based on their allocation policy. State exchange between the two nodes may be necessary to make updates or adjustments. To implement, shared memory across both DPU nodes can be utilized. Updates made by the primary node would be immediately visible to the shadow node, allowing for seamless coordination and decision-making. The shadow node can also use its own hidden data structure to record decisions that might not align with policy, providing an additional layer of flexibility, highlighting the importance of distributed box sharing in managing complexity across multiple nodes. By leveraging shared memory and coordinated decision-making, efficient and stateless operations between data planes can be achieved even when multiple functions are distributed across multiple nodes.

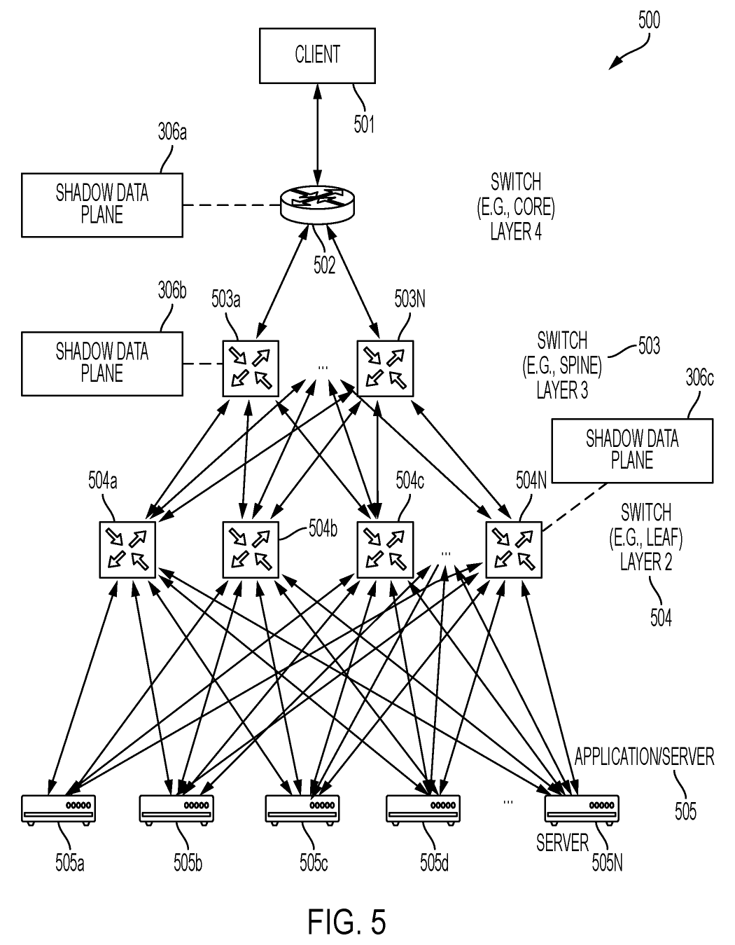

FIG. 5 illustrates a diagram of an example cloud data center architecture, according to some aspects of the present disclosure. Cloud data center architecture 500 can be implemented by one or more clouds in a multi-cloud environment. Cloud data center architecture 500 is an example of a network in which SRv6 and IPv6 can be leveraged. However, the present disclosure is not limited thereto and can be applied to any other type of known or to be developed network in which SRv6 and IPv6 can be leveraged.

The cloud data center architecture 500 can include a cloud, which can be a private cloud, a public cloud, a hybrid cloud, a virtual private cloud (VPC), a cloud region, etc. The cloud can host one or more data centers and/or networks. For example, the cloud can include a single data center or a plurality of data centers. The cloud can be physically located in one geographic location or distributed throughout multiple geographic locations. Moreover, the cloud can include forwarder-side and server-side architectures or components.

The client 501 can be a network, such as a cloud network or data center (e.g., a private cloud, a public cloud, a hybrid cloud, a cloud region or segment, a virtual private cloud, etc.), or any computing device, such as a laptop, a desktop, a tablet computer, a mobile phone, a server, a smart device (e.g., smart television, smart watch, etc.), an internet of things (IoT) device, etc.

The client 501 can connect to the cloud and access servers 505a, 505b, 505c, 505d through 505N (collectively “505” hereinafter) via a core switch 502. The core switch 502 may be a core switch that typically is located at a center of the cloud data center architecture 500, connecting to multiple spines together.

The spine switches 503a through 503N (collectively “503” hereinafter) and leaf switches 504a, 504b, 504c, through 504N (collectively “504” hereinafter) configured to route traffic in the cloud data center architecture 500. The spine switches 503 can include any network device with layer 2 (L2) and/or layer 3 (L3) capabilities.

The spine switches 503 can serve as edge devices in the cloud, and route traffic to and from the cloud. The spine switches 503 can thus serve as the egress and ingress point for the cloud. The spine switches 503 can also route traffic to the leaf switches 504 in the cloud , which can route traffic to other nodes (e.g., appliances, firewalls, load balancers, etc.) and servers 505 in the cloud.

Shadow data plane 306 that operates on the core switch 502 or on the spine switches 503 (such as shadow data plane 306a and shadow data plane 306b) or elsewhere may be able to observe, process, act on, and forward marked dataflow 316 in the shadow data plane 306 or the active data plane 304. Shadow data plane 306 that operates in the leaf switches 504 (such as shadow data plane 306c) may mark the marked dataflow 316, process, and forward the marked dataflow 316.

Multiple methods (see FIGS. 5-7) are proposed below for traffic marking for shadow data plane handling and forwarding. Marked packets in the traffic flow indicate that they should be handled by the shadow data plane path within each device along that path. Such a marking can be done by a variety of methods. Note, methods of traffic tagging noted should be in-band, such there is no dependence on the devices in the path to inspect the traffic at any deep level.

The servers 505 can represent physical machines and/or resources hosting applications, isolated environments, or services in the cloud. For example, the servers 505 can be physical servers running various applications in the cloud. The servers 505 can run some or all of their applications in isolated environments, such as VMs or software containers. In some cases, an application can by hosted by, and/or run on, servers 505 in the cloud. For example, servers 505 can run instances of an application (e.g., virtual instances, replicas, parallel instances, mirror instances, etc.).

The servers 505 can include a physical network interface (e.g., NIC) to communicate with other devices or services (e.g., devices or services in the cloud data center architecture 500). The physical network interface can be assigned a physical prefix or network address for such communications. The servers 505 can also include one or more virtual interfaces (e.g., vNICs) which can provide virtualized or abstract representations of network interfaces and connections. Virtual interfaces can provide added flexibility and network capabilities, as well as various other benefits or services, such as aggregation of links or data, isolation of data or networks, decoupling of application and system traffic, expansion of network interfaces, network redundancy, dedicated links, and so forth. Virtual interfaces can be assigned virtual addresses (e.g., VIPs) in the cloud. The virtual addresses can identify the virtual interfaces as well as any applications or isolated environments associated with the virtual addresses on the servers 505.

For example, an application can be assigned a virtual address in the cloud, which can be used to identify the application in the cloud and route traffic to and from the application. The virtual address can be used to steer traffic to and from a virtual instance of the application running on one or more of the servers 505. In some cases, the virtual address can be mapped to the same application on servers 505, and can be used to communicate with an instance of the application on any of the servers 505.

In some cases, the servers 505 can include a virtual switch, such as OVS or VPP, which can route traffic to and from the servers 505. For example, a virtual switch can route traffic between physical and virtual network interfaces on an application server, between applications and/or isolated environments on the application server, and between the application server and devices or applications outside of the application server. To illustrate, an application server can run multiple workloads (e.g., applications in different VMs or containers) assigned to different virtual interfaces and virtual addresses. A virtual switch on the application server can route traffic to and from the different workloads by translating the virtual addresses of the workloads and communicating with the virtual interfaces as well as other network interfaces such as the physical network interface(s) on the application server.

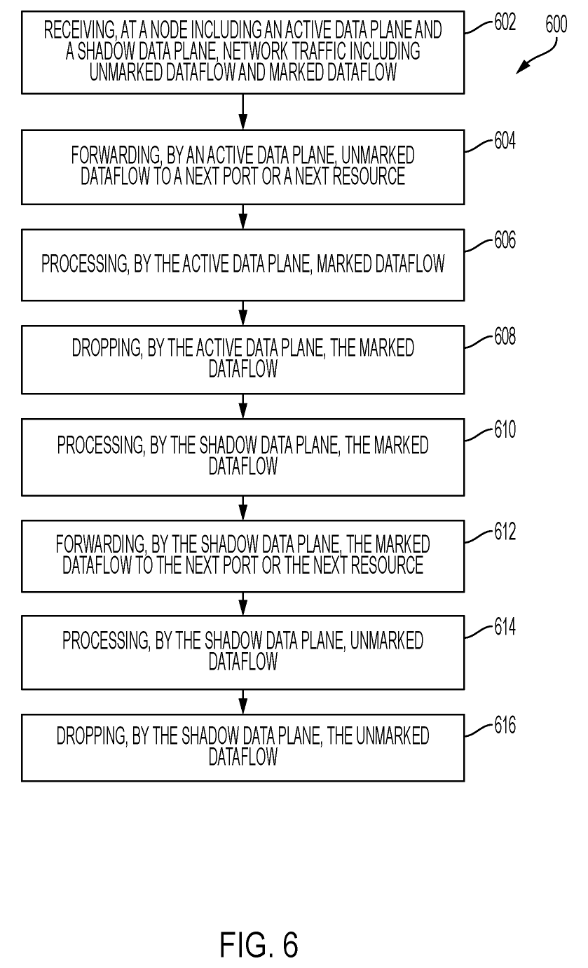

FIG. 6 illustrates an example method 600 for managing flow of data within a controlled boundary using a shadow data plane. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some examples, the method includes receiving, at a node including an active data plane and a shadow data plane, network traffic including unmarked dataflow and marked dataflow at step 602.

According to some examples, the method includes forwarding, by the active data plane, unmarked dataflow to a next port or a next resource at step 604.

According to some examples, the method includes processing, by the active data plane, marked dataflow at step 606.

According to some examples, the method includes dropping, by the active data plane, the marked dataflow at step 608.

According to some examples, the method includes processing, by the shadow data plane, the marked dataflow at step 610.

According to some examples, the method includes forwarding, by the shadow data plane, the marked dataflow to the next port or the next resource at step 612. In some cases, the marked dataflow is sent to a next MAC address associated with a next shadow data plane, wherein the marked dataflow is implicitly marked based on a received MAC address associated with the shadow data plane.

According to some examples, the method includes processing, by the shadow data plane, unmarked dataflow at step 614.

According to some examples, the method includes dropping, by the shadow data plane, the unmarked dataflow at step 616.

In some cases, the method includes switching the active data plane and the shadow data plane.

In some cases, a control plane agent informs the active data plane and the shadow data plane regarding marking traffic to be processed by the active data plane and the shadow data plane. In some cases, the control plane agent is controlling a core switch or a spine switch, wherein method further includes performing an action, by the shadow data plane, to the marked dataflow. In some cases, the action includes network packet processing, traffic forwarding, policy enforcement, security functions, or observing the marked dataflow.

In some cases, the active data plane and the shadow data plane run on a node. In some cases, the node is a network enforcement device, and the marked dataflow and the unmarked dataflow are networking traffic-related dataflow. A network enforcement device may be a switch, router, or firewall that can apply policy, such as a network access control list, to the content of a packet to determine whether that dataflow / packet should be forwarded, dropped, or some other action taken upon it (spanned / logged). In other cases, the node is a container or a cluster in a data center compute architecture, and the marked dataflow and the unmarked dataflow are application communications.

In some cases, one or more services that are mirrored between the active data plane and the shadow data plane are turned off at the shadow data plane. In some cases, the active data plane and the shadow data plane have different configurations for which action to perform.

In some cases, the marked dataflow is distinguished from the unmarked dataflow by an in-band explicit marking that is examined by data plane processing or an out-of-band implicit marking that is determined based on configuration.

In some cases, the in-band explicit marking or the out-of-band implicit marking is dropped when exiting the controlled boundary. In some cases, the in-band explicit marking includes a most-significant bit of an Internet Protocol Fragment Offset field in an Internet Protocol packet header, Differentiated Services Code Point values with assigned odd-numbered values, non-standard combinations of Explicit Congestion Notification flag bits within a Differentiated Services Code Point byte in the Internet Protocol header, or non-standard Transmission Control Protocol options inserted in the Transmission Control Protocol header, or packet metadata encoded into the Ethernet frame preamble.

In some cases, with respect to IPv6 and SRv6, IPv6 Flow Labels may be used to tag prioritized shadow traffic in compliance with RFC 6437.

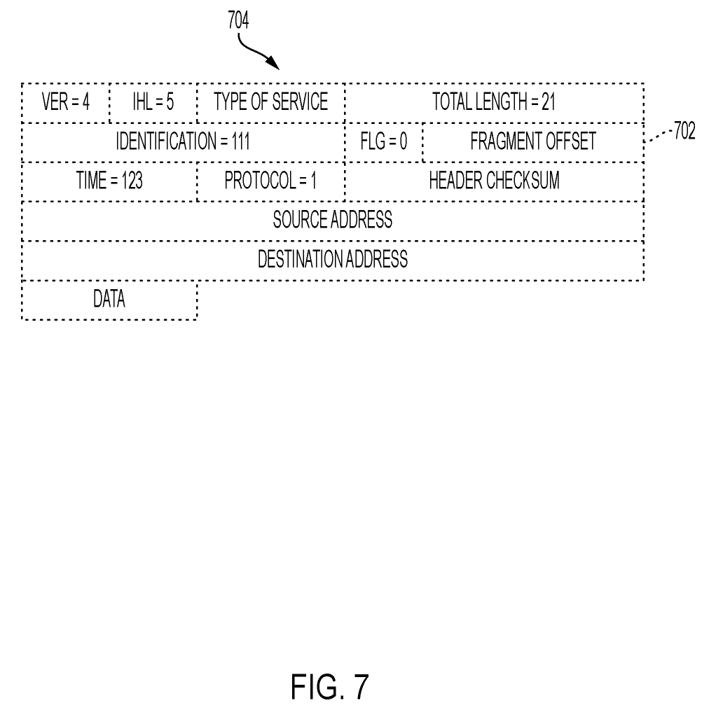

FIG. 7 illustrates a first example method for marking dataflow.

In some cases, the marked dataflow is marked prior to reaching or at the node. The first example method includes utilizing a most-significant bit (MSB) of an IP Fragment Offset field 702 in an IPv4 packet header 704 as a flag to indicate traffic that should be processed and dropped by the active data plane and forwarded by the shadow data plane. The MSB is the only unused bit in the entire IPv4 header, reserved and set to 0 according to Request for Comments (RFC) 791. To maintain compliance with the standard, the bit must be reset to 0 when exiting the domain involved. However, within the bounds of the testing domain (e.g., Data Center), the bit can be used to flag traffic for handling by the shadow data plane. The advantages of such a method include its simplicity and ease of detection in a traffic stream, making it feasible to implement using programmable ASICs or DPU.

The initial marking of designated traffic flows can be performed by matching traffic on ingress nodes via ACLs, followed by subsequent multi-hop shadow data plane handling. Notably, the MSB is not used for any purpose and has never been assigned in RFC 791. The testing domain bounds are defined as the Organizational Domain, which encompasses a specific scope. If such a method were to be used, it would not comply with RFC 791 due to its reserved nature and requirement that the bit must be set to 0. Therefore, when traffic exits the second node, the bit should be reset to 0 to maintain compliance. Such a method is intended for use within a bounded domain, where all shadow data planning and testing occur. It may involve multiple hops and is suited for testing new software loads or policy updates. Such an approach ensures that the testing environment remains strictly controlled, allowing for the evaluation of specific policies without affecting the broader network.

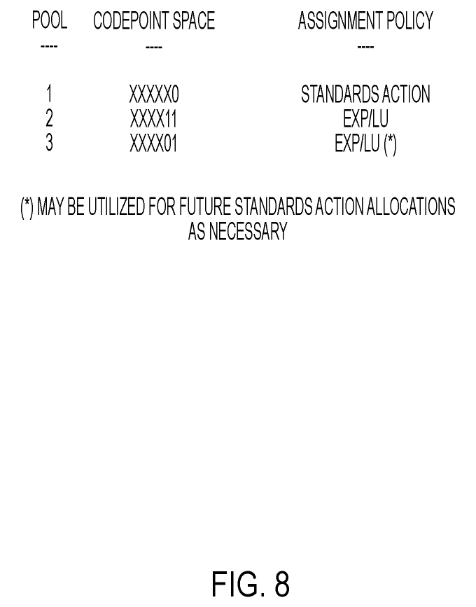

FIG. 8 illustrates a second example method for marking dataflow.

The second example method includes replacing assigned DSCP values with odd-numbered values to create a new, unique value. Since all even-numbered DSCP values are assigned from pool one and end in zero, making them even numbers, only odd-numbered values remain available for use. The proposed marking involves using the odd-numbered values to tag traffic, replacing the original DSCP value with the new odd-value DSCP.

Such an approach leverages the existing infrastructure and tools that can easily identify and process DSCP values. Programmatic implementation of programmable ASICs or DPU is feasible due to the simplicity of detecting the odd-numbered values in a DSCP field. Overall, both methods offer viable solutions for implementing shadow data plane functionality within a controlled testing environment, ensuring compliance with relevant standards while allowing for the evaluation of new policies and software loads.

In the context of DSCP markings, odd-value DSCPs often correspond to Local Use / Experimental (LU/EXP) values as defined in RFC 4594. These markings fall outside of the standardized per-hop behaviors (PHBs) and are designated for experimental or private use within a specific administrative domain. While standardized DSCP values typically align with even-numbered codes to map to predefined forwarding treatments, odd-numbered DSCP values often indicate either local experimentation or vendor-specific implementations that do not conform to IETF-defined PHBs.

The LU/EXP DSCP markings can be particularly useful in testing, proprietary QoS schemes, or transitional deployments where operators need to distinguish traffic classes without conflicting with standardized DSCP allocations. For instance, an organization may use odd-numbered DSCPs to denote traffic requiring special handling within their network—such as internal telemetry, control-plane prioritization, or specialized low-latency applications—without affecting interoperability with external networks that follow conventional DSCP mappings. Since LU/EXP DSCP values are not guaranteed to retain meaning across domain boundaries, they are best suited for use in environments where traffic remains under a single administrative authority or where explicit agreements exist between peering networks.

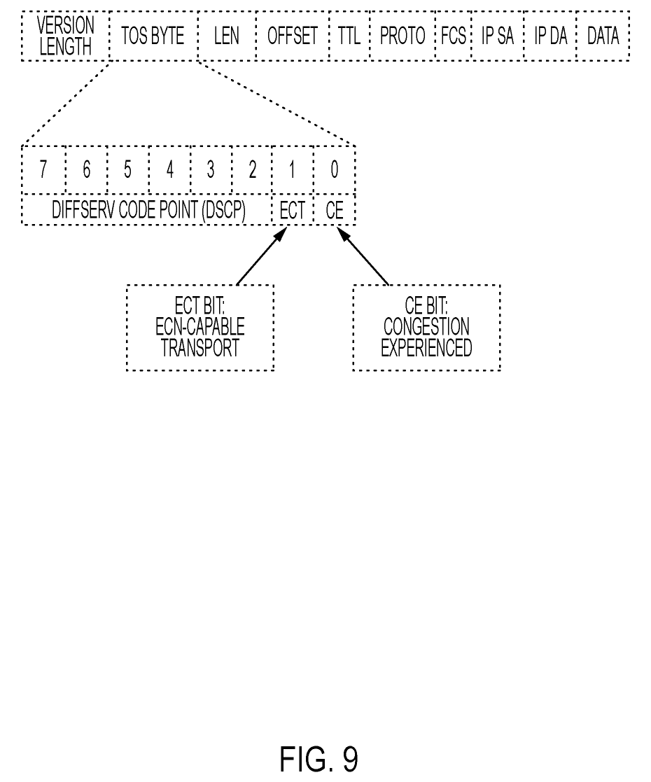

FIG. 9 illustrates a third example method for marking dataflow.

The third method for flagging designated traffic flows for processing and forwarding by the shadow data plane utilizes non-standard combinations of the ECN (Explicit Congestion Notification) flag bits within the DSCP (Diffserv Code Point) byte in the IP header. The last two bits of the IP ToS Byte are assigned for IP ECN, specifically: the ECN Capable Transport (ECN) bit and the Congestion Experienced (CE) bit. The definition of the bits allows for a logically contradictory combination that can be used as a special flag, known as the "IP ECN Flag." The specific bit-combination, ECT = 0 and CE = 1, conveys no practical and meaningful information in itself.

However, the particular combination could be used to indicate processing and forwarding of traffic in the shadow data plane. In other words, when the IP ECN flag is set, the DSCP bits preceding it should be interpreted in a special, locally significant manner, which could mean that the traffic flows flagged with the IP ECN flag are subject to additional processing and forwarding rules within the shadow data plane. Furthermore, the DSCP bits in such a case could also optionally specify additional optional traffic handling attributes within the shadow data plane if desired. Such a process provides a flexible way to handle different types of traffic and ensure that they are processed and forwarded according to their specific requirements.

As such, the use of non-standard combinations of ECN flag bits within the DSCP byte can be leveraged as a special flag to indicate processing and forwarding in the shadow data plane. By setting the ECT bit to 0 (indicating that the transport does not support IP explicit congestion notification) and the CE bit to 1 (indicating that congestion was experienced), a specific traffic flow can be flagged for special treatment, potentially leading to improved network performance and efficiency.

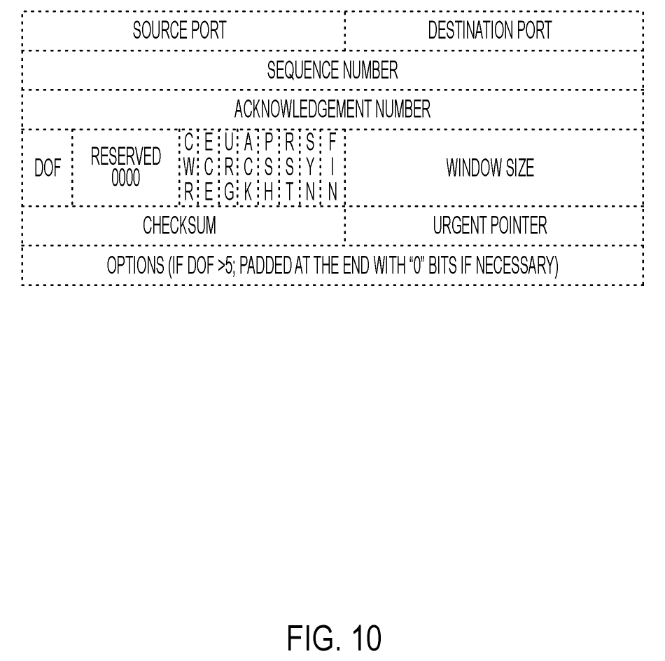

FIG. 10 illustrates a fourth example method for marking dataflow.

The fourth example method for marking involves inserting non-standard TCP options in the TCP header to indicate the need for multi-hop shadow plane data handling, with the goal of being recognized by specific systems or networks before the marking is stripped out when leaving the domain.

The insertion of non-standard TCP options can be achieved through various methods, but one common technique involves using a proprietary packet manipulation library, such as pvpf-based techniques, which are more suitable for CPU-based implementations. Alternatively, the use of eBPF (Extended Berkeley Packet Filter) based packet manipulation on host systems could also be employed to achieve such a capability.

Such an approach has an advantage as intermediate network nodes typically do not modify the TCP Options field, which means that the marked packet will survive multiple hops without issues. TCP Option Fields: The fields within a TCP option can be categorized into several groups based on their function and location in the header, including:
1. Source Port (16 bits): The port number of the sender.
2. Destination Port (16 bits): The port number of the receiver.
3. Sequence Number (32 bits): Indicates the sequence number of the first byte of data in this segment. If the SYN flag is set, this is the initial sequence number.
4. Acknowledgment Number (32 bits): If the ACK flag is set, this field contains the value of the next sequence number that the sender expects to receive.
5. Data Offset (4 bits): Indicates the size of the TCP header in 32-bit words.
6. Reserved (3 bits): Reserved for future use and should be set to zero.
7. Control Flags (9 bits): Includes flags such as URG, ACK, PSH, RST, SYN, and FIN, which control various aspects of TCP connection management.
8. Window Size (16 bits): The size of the sender's receive window (buffer space) that is available.
9. Checksum (16 bits): Used for error-checking the header and data.
10. Urgent Pointer (16 bits): If the URG flag is set, this field points to the end of the urgent data.
11. Options and Padding: Optional fields for various TCP options such as maximum segment size, timestamp, etc., and padding to ensure the header is a multiple of 32 bits.

Given the extensive modifications required to insert and remove TCP Option data (increase in length, change to TCP and IP checksums, etc.), it's likely that this capability would be best performed in a host or DPU implementation. Such a method may not be amenable to ASIC implementation due to the complexity involved in packet manipulation. However, within a host environment, eBPF-based packet manipulation can provide an effective solution without requiring direct coding support within the host application itself.

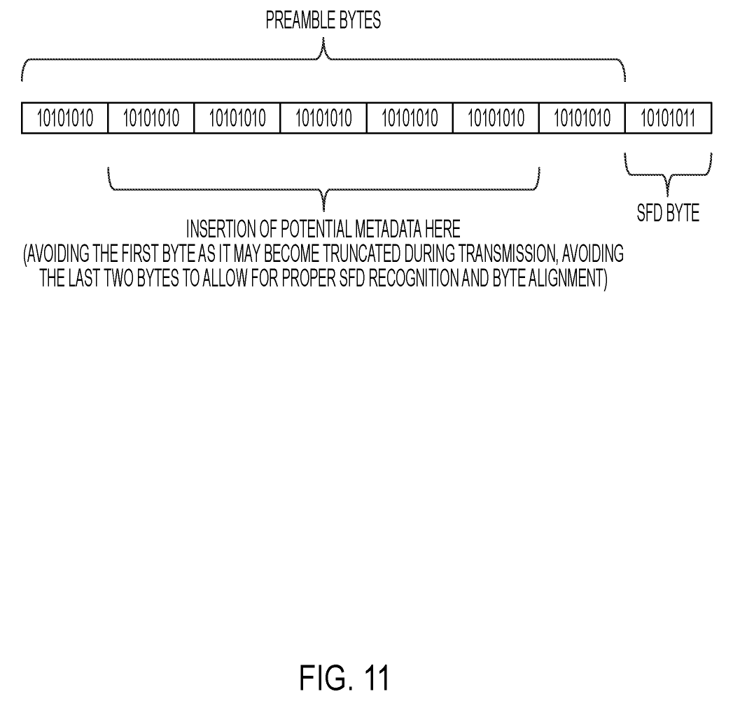

FIG. 11 illustrates a fifth example method for marking dataflow.

The fifth example method of marking packet metadata using controller-led link-level sub-rosa metadata propagation in Ethernet systems involves hiding the metadata within the Ethernet preamble. The preamble is a 56-bit sequence at the beginning of an Ethernet packet header, consisting of alternating 1010101010 bits followed by a starter frame delimiter byte (10101011). Such a design allows for two primary functions: to wake up receiving systems and enable them to detect byte boundaries. In traditional Ethernet systems, hubs would chop off a few bits from the preamble due to their limited processing capabilities. However, with modern switch-based Ethernet systems, such a limitation no longer exists, as switches regenerate new packets on the outbound path rather than simply repeating bits.

The fifth example method exploits such an advantage by inserting metadata into the preamble, which requires updated PHY and ASIC/DPU hardware support. The metadata inserted in the preamble can vary depending on the specific implementation requirements. In the context of the original proposal (CPOL 1039906), examples of potential metadata included information about suspicious traffic, such as the source node or Kubernetes cluster origin. The policy used for marking would be simple: if a packet contains marking metadata in the five-bit space, it would be shuttled into a shadow data plane. It is essential to note that such a method introduces a hop by hop marking approach, where once traffic is marked with metadata, it cannot be unmarked. In contrast, traditional markings can often be removed or updated as needed. Additionally, the proposed method ensures that the metadata remains preserved within the preamble and can be reinserted into subsequent packets if necessary.

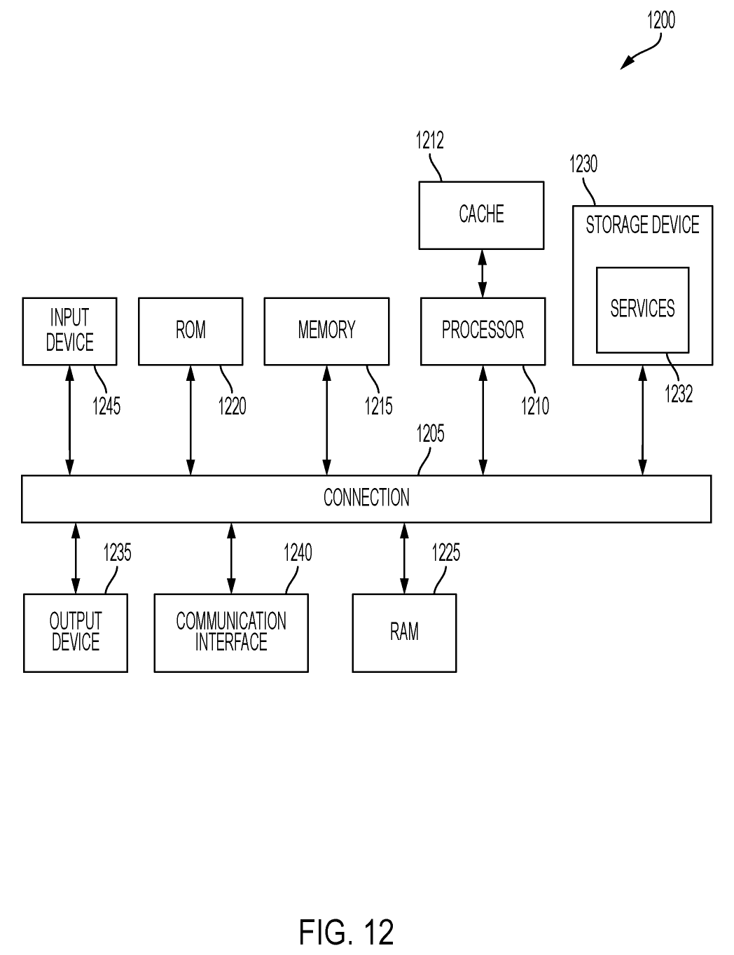

FIG. 12 shows an example of a computing system 1200, which can be for example any computing device or any component thereof in which the components of the system are in communication with each other using connection 1205. Connection 1205 can be a physical connection via a bus, or a direct connection into processor 1210, such as in a chipset architecture. Connection 1205 can also be a virtual connection, networked connection, or logical connection.

In some embodiments computing system 1200 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Computing system 1200 includes at least one processing unit (CPU or processor) (e.g., processor 1210) and connection 1205 that couples various system components including system memory 1215, such as read only memory 1220 and random access memory 1225 to processor 1210. Computing system 1200 can include a cache of high-speed memory 1212 connected directly with, in close proximity to, or integrated as part of processor 1210.

Processor 1210 can include any general purpose processor and a hardware service or software service, such as services 1232 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms known to those of skill in the art. In some instances, multimodal systems can enable a user to provide multiple types of input/output to communicate with computing system 1200. Computing system 1200 can include communications interface 1240, which can generally govern and manage the user input and system output. There is no restriction on operating on any particular hardware arrangement and therefore the basic features here may easily be substituted for improved hardware or firmware arrangements as they are developed.

Storage device 1230 can be a non-volatile memory device and can be a hard disk or other types of computer readable media which can store data that are accessible by a computer, such as magnetic cassettes, flash memory cards, solid state memory devices, digital versatile disks, cartridges, random access memories, read only memory, and/or some combination of these devices.

The storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method of managing flow of data within a controlled boundary using a shadow data plane, the method comprising:
receiving, at a node including an active data plane and a shadow data plane, network traffic including unmarked dataflow and marked dataflow;
forwarding, by the active data plane, the unmarked dataflow to a next port or a next resource;
processing, by the active data plane, the marked dataflow;
dropping, by the active data plane, the marked dataflow;
processing, by the shadow data plane, the marked dataflow;
forwarding, by the shadow data plane, the marked dataflow to the next port or the next resource;
processing, by the shadow data plane, the unmarked dataflow; and
dropping, by the shadow data plane, the unmarked dataflow.

2. The method of claim 1, wherein the node is a network enforcement device.

3. The method of claim 1, wherein the node is a container or a cluster in a data center compute architecture, and wherein the marked dataflow and the unmarked dataflow are application communications.

4. The method of claim 1, wherein one or more services that are mirrored between the active data plane and the shadow data plane are turned off at the shadow data plane.

5. The method of claim 1, wherein the marked dataflow is marked prior to reaching or at the node and is distinguished from the unmarked dataflow by an in-band explicit marking that is examined by data plane processing or an out-of-band implicit marking that is determined based on configuration.

6. The method of claim 5, further comprising:
dropping the in-band explicit marking or the out-of-band implicit marking when exiting the controlled boundary.

7. The method of claim 5, wherein the in-band explicit marking includes a most-significant bit of an Internet Protocol Fragment Offset field in an Internet Protocol packet header, Differentiated Services Code Point values with assigned odd-numbered values, non-standard combinations of Explicit Congestion Notification flag bits within a Differentiated Services Code Point byte in the Internet Protocol packet header, or non-standard Transmission Control Protocol options inserted in a Transmission Control Protocol header, or packet metadata encoded into an Ethernet frame preamble.

8. A system for managing flow of data within a controlled boundary using a shadow data plane, the system comprising:
one or more memories having computer-readable instructions stored thereon; and
one or more processors configured to execute the computer-readable instructions to:
receiving, at a node including an active data plane and a shadow data plane, network traffic including unmarked dataflow and marked dataflow, and
wherein the active data plane is configured to:
forward, by an active data plane, the unmarked dataflow to a next port or a next resource;
process, by the active data plane, the marked dataflow; and
drop, by the active data plane, the marked dataflow;
wherein the shadow data plane is configured to:
process, by the shadow data plane, the marked dataflow;
forward, by the shadow data plane, the marked dataflow to the next port or the next resource;
process, by the shadow data plane, the unmarked dataflow; and
drop, by the shadow data plane, the unmarked dataflow.

9. The system of claim 8, wherein the node is a network enforcement device.

10. The system of claim 8, wherein the node is a container or a cluster in a data center compute architecture, and wherein the marked dataflow and the unmarked dataflow are application communications.

11. The system of claim 8, wherein one or more services that are mirrored between the active data plane and the shadow data plane are turned off at the shadow data plane.

12. The system of claim 8, wherein the marked dataflow is marked prior to reaching or at the node and is distinguished from the unmarked dataflow by an in-band explicit marking that is examined by data plane processing or an out-of-band implicit marking that is determined based on configuration.

13. The system of claim 12, wherein the one or more processors is further configured to execute the computer-readable instructions to:
dropping the in-band explicit marking or the out-of-band implicit marking when exiting the controlled boundary.

14. The system of claim 12, wherein the in-band explicit marking includes a most-significant bit of an Internet Protocol Fragment Offset field in an Internet Protocol packet header, Differentiated Services Code Point values with assigned odd-numbered values, non-standard combinations of Explicit Congestion Notification flag bits within a Differentiated Services Code Point byte in the Internet Protocol packet header, or non-standard Transmission Control Protocol options inserted in a Transmission Control Protocol header, or packet metadata encoded into an Ethernet frame preamble.

15. A non-transitory computer readable medium having instructions encoded thereon that, when executed by a processor, cause the processor to:
receive, at a node including an active data plane and a shadow data plane, network traffic including unmarked dataflow and marked dataflow;
forward, by the active data plane, the unmarked dataflow to a next port or a next resource;
process, by the active data plane, the marked dataflow;
drop, by the active data plane, the marked dataflow;
process, by the shadow data plane, the marked dataflow;
forward, by the shadow data plane, the marked dataflow to the next port or the next resource;
process, by the shadow data plane, the unmarked dataflow; and
drop, by the shadow data plane, the unmarked dataflow.

16. The non-transitory computer readable medium of claim 15, wherein the node is a network enforcement device.

17. The non-transitory computer readable medium of claim 15, wherein the node is a container or a cluster in a data center compute architecture, and wherein the marked dataflow and the unmarked dataflow are application communications.

18. The non-transitory computer readable medium of claim 15, wherein one or more services that are mirrored between the active data plane and the shadow data plane are turned off at the shadow data plane.

19. The non-transitory computer readable medium of claim 15, wherein the marked dataflow is marked prior to reaching or at the node and is distinguished from the unmarked dataflow by an in-band explicit marking that is examined by data plane processing or an out-of-band implicit marking that is determined based on configuration.

20. The non-transitory computer readable medium of claim 19, wherein the processor is further caused to:
drop the in-band explicit marking or the out-of-band implicit marking when exiting a controlled boundary.
